(19) United States
(12) Patent Application Publication
(10) Pub. No.: US 2026/0233594 A1
(43) Pub. Date: Aug. 13, 2026

(54) WEATHER STRIP

(71) Applicant: NISHIKAWA RUBBER CO., LTD., Hiroshima (JP)

(72) Inventors: Koichi TERASAKI, Hiroshima (JP); Yuichi NUIBE, Hiroshima (JP)

(21) Appl. No.: 19/381,140

(22) Filed: Nov. 6, 2025

(30) Foreign Application Priority Data
Feb. 12, 2025 (JP) 2025-021024

(51) Int. Cl. B60J 10/84; B60J 10/24

(52) U.S. Cl. CPC B60J 10/84; B60J 10/24

(57) ABSTRACT

Provided is a weather strip having both a low specific gravity and a low water absorption rate. The weather strip to be attached to an automobile includes a hollow sealing part having a hollow space formed therein, and the hollow sealing part includes a foamed wall part that is at least part of a wall forming the hollow space, that has bubbles formed therein, the number of the bubbles being not less than 200/mm², at least some of the bubbles each being derived from a thermally expandable microcapsule, that has a thickness of not less than 1.0 mm and not more than 2.0 mm, and that has a specific gravity of not more than 0.45.

This Nonprovisional application claims priority under 35 U.S.C. § 119 on Patent Application No. 2025-021024 filed in Japan on Feb. 12, 2025, the entire contents of which are hereby incorporated by reference.

### TECHNICAL FIELD

The present invention relates to a weather strip.

### BACKGROUND ART

For a weather strip to be attached to an automobile, attempts have been made to reduce a specific gravity of the weather strip, in order to achieve weight reduction. As a method for reducing the specific gravity, for example, a method is known in which a material of the weather strip is foamed into a sponge-like form.

For example, Patent Literature 1 discloses a weather strip for automobiles that is obtained by molding a silicone rubber sponge composition containing thermally expandable microcapsules and an organic foaming agent.

### CITATION LIST

### Patent Literature

### Patent Literature 1

Japanese Patent Application Publication, Tokukaihei, No. 8-12797

### SUMMARY OF INVENTION

### Technical Problem

However, the weather strip for automobiles disclosed in Patent Literature 1 has room for improvement in terms of maintaining a low water absorption rate while reducing the specific gravity.

It is an object of an aspect of the present invention to provide a weather strip and the like which achieve both a low specific gravity and a low water absorption rate.

### Solution to Problem

In order to attain the object, a weather strip in accordance with an aspect of the present invention is a weather strip to be attached to an automobile, the weather strip including a hollow sealing part having a hollow space formed therein, wherein the hollow sealing part includes a foamed wall part that is at least part of a wall forming the hollow space, and the foamed wall part has bubbles formed therein, the number of the bubbles being not less than 200/mm² in a given cross section, at least some of the bubbles each being derived from a thermally expandable microcapsule, has a thickness of not less than 1.0 mm and not more than 2.0 mm, and has a specific gravity of not more than 0.45.

### Advantageous Effects of Invention

According to an aspect of the present invention, it is possible to provide a weather strip and the like which achieve both a low specific gravity and a low water absorption rate.

### BRIEF DESCRIPTION OF DRAWINGS

FIG. 1 is a side view schematically illustrating a left side surface of an automobile to which a weather strip in accordance with Embodiment 1 is attached.

FIG. 2 is a cross-sectional view schematically illustrating a shape of the weather strip in accordance with Embodiment 1, taken along line II-II shown in FIG. 1.

FIG. 3 is a diagram showing cross-sectional photographs of a foamed wall part of a weather strip in accordance with Example 1 and the number of bubbles in the foamed wall part.

FIG. 4 is a diagram showing cross-sectional photographs of a foamed wall part of a weather strip in accordance with Comparative Example 1 and the number of bubbles in the foamed wall part.

FIG. 5 is a diagram showing cross-sectional photographs of a foamed wall part of a weather strip in accordance with Comparative Example 2 and the number of bubbles in the foamed wall part.

FIG. 6 is a diagram showing cross-sectional photographs of a foamed wall part of a weather strip in accordance with Comparative Example 3 and the number of bubbles in the foamed wall part.

### DESCRIPTION OF EMBODIMENTS

The following description will discuss an embodiment of the present invention in detail. In the present specification, the numerical range “A to B” indicates “not less than A and not more than B,” inclusive of the endpoints.

### Weather Strip 10

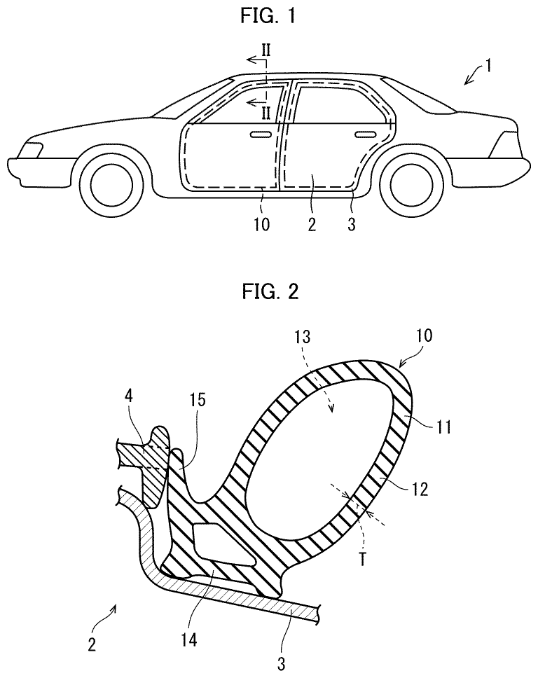

FIG. 1 is a side view schematically illustrating a left side surface of an automobile 1 to which a weather strip 10 in accordance with the present embodiment is attached. FIG. 2 is a cross-sectional view schematically illustrating a shape of the weather strip 10 in accordance with the present embodiment, taken along line II-II shown in FIG. 1. In an example illustrated in FIG. 1, an upper side, a lower side, a left-hand side, and a right-hand side of a drawing sheet of FIG. 1 correspond to a vertically upper side, a vertically lower side, a front side, and a rear side, respectively. In an example illustrated in FIG. 2, a left-hand side and a right-hand side of a drawing sheet of FIG. 2 correspond to a vehicle exterior side and a vehicle interior side, respectively.

As illustrated in FIG. 1, the automobile 1 includes a door 2 for closing a door opening. The door 2 has a flange 3 formed in a circumferential edge part thereof on the vehicle interior side. As illustrated in FIG. 2, the weather strip 10 is a member that is attached to the flange 3 and seals a gap between a circumferential edge part of the automobile 1 surrounding the door opening, and the door 2. The weather strip 10 may be in contact with another sealing member, such as a door-side seal 4 attached to the door 2.

It should be noted that the weather strip 10 is not limited to being attached to the door 2 of the automobile 1 and may be attached to any positions in the automobile 1. For example, the weather strip 10 may be attached to a circumferential edge part surrounding an engine room opening or to an engine hood, or may be attached to a circumferential edge part surrounding a luggage compartment opening or to a luggage compartment door.

### Configuration of Weather Strip 10

As illustrated in FIG. 2, the weather strip 10 includes a hollow sealing part 11, a foamed wall part 12, a base part 14, and a lip 15. It should be noted that on the condition that the weather strip 10 includes the hollow sealing part 11 and the foamed wall part 12, the configuration of the rest of the weather strip 10 is not particularly limited. For example, the weather strip 10 may not include the lip 15, or may include a plurality of lips in addition to the lip 15.

The base part 14 is a portion of the weather strip 10 which portion is attached to the flange 3. The manner in which the base part 14 is attached to the flange 3 is not particularly limited. For example, the base part 14 may be attached to the flange 3 using an adhesive or the like, may be attached via an attachment member such as a clip, or may be fitted into a groove or the like formed in the flange 3.

The lip 15 is a tongue-shaped portion that comes into contact with the door-side seal 4 of the door 2. The lip 15 ensures that, when the door 2 is in a closed state, the weather strip 10 does not bend excessively and the posture of the weather strip 10 can be stably maintained.

The hollow sealing part 11 is a portion that, when the door 2 is in a closed state, comes into contact with the circumferential edge part of the automobile 1 surrounding the door opening and seals the gap between the circumferential edge part surrounding the door opening, and the door 2. The hollow sealing part 11 has a hollow space 13 formed therein. When the hollow sealing part 11, in which the hollow space 13 is formed, comes into contact with the circumferential edge part of the automobile 1 surrounding the door opening, the hollow sealing part 11 easily undergoes elastic deformation in accordance with the shape of the circumferential edge part and the state of contact with the circumferential edge part. As such, it is possible to tightly seal the gap between the circumferential edge part surrounding the door opening, and the door 2. This makes it possible to improve the waterproof performance and the soundproof performance when the door 2 is in the closed state.

The hollow sealing part 11 has, at least in part, the foamed wall part 12, which will be described later.

### Material of Weather Strip 10

The material of the weather strip 10 may be a material that contains an elastomer as a main component. In the present specification, the term “elastomer” refers to a polymer having elasticity and encompasses rubbers and thermoplastic elastomers (TPE). Note that the weather strip 10 may contain various additive components as needed, in addition to the elastomer.

Examples of rubber include vulcanized rubber containing natural rubber and synthetic rubber. Examples of TPE include block copolymers having a hard segment and a soft segment, particularly TPEs of polystyrene-based, olefin-based, polyvinyl chloride-based, polyurethane-based, polyester-based, and polyamide-based types.

From the perspective of improving the elasticity of the weather strip 10, the elastomer may be an ethylene-propylene-diene rubber (EPDM). Alternatively, from the perspective of achieving a lower specific gravity of the weather strip 10, energy saving during the production of the weather strip 10, or improved recyclability of the weather strip 10, the elastomer might be TPE, particularly an olefin-based TPE (TPO).

The material of the weather strip 10 may be in a non-foamed state (solid form) or in a foamed state (sponge-like form). From the perspective of achieving a lower specific gravity of the weather strip 10, it is preferable that at least part of the weather strip 10 be in a sponge-like form. In the weather strip 10 in accordance with the present embodiment, the foamed wall part 12, which is at least part of the hollow sealing part 11, is provided in a sponge-like form. The weather strip 10 may be in a sponge-like form also at portions other than the foamed wall part 12.

### Foamed Wall Part 12

The foamed wall part 12 is at least part of a wall of the hollow sealing part 11 which wall forms the hollow space 13. The foamed wall part 12 is defined as a portion of the hollow sealing part 11 which portion (i) has bubbles formed therein, the number of the bubbles being not less than 200/mm² in a given cross section, and (ii) has a thickness T of not less than 1.0 mm and not more than 2.0 mm and a specific gravity of not more than 0.45.

The hollow sealing part 11 may be entirely configured as the foamed wall part 12 or may have the foamed wall part 12 only in part. In a case where the hollow sealing part 11 has the foamed wall part 12 only in part, it is preferable that the rest of the hollow sealing part 11 be in a foamed, sponge-like form and have a thickness T or a specific gravity falling within the numerical range specified for the foamed wall part 12.

The foamed wall part 12 has bubbles formed therein, the number of which is not less than 200/mm² in a given cross section. The “given cross section” may refer to a cross section obtained by cutting the foamed wall part 12 in any direction, provided that the cross section has an area of not less than 1 mm². The number of bubbles observed in the given cross section can be counted by visual observation. When a portion of a bubble is connected to another bubble such that voids are continuous, these bubbles are collectively counted as a single bubble based on their shape. That is, the number of bubbles is defined as the number of continuous voids formed.

At least some of the bubbles formed in the foamed wall part 12 are each derived from a thermally expandable microcapsule. The bubbles formed in the foamed wall part 12 can be classified into first bubbles, which are bubbles derived from thermally expandable microcapsules, and second bubbles, which are bubbles other than the first bubbles.

The first bubbles are bubbles each formed by expansion of a thermally expandable microcapsule. The thermally expandable microcapsule is a substance that expands upon heating. The thermally expandable microcapsule is configured such that a chemical substance, such as hydrocarbon, that gasifies upon heating, or a gas itself that expands upon heating, is encapsulated within a shell. The shape of the shell of the thermally expandable microcapsule is maintained even when a foaming start temperature is reached. Note that the shell may become softened by heating. When the foaming start temperature is reached, the chemical substance or the gas encapsulated within the shell expands inside the shell. The first bubbles can be formed during the production process of the weather strip 10 by adding the thermally expandable microcapsules to the foamed wall part 12 and heating the thermally expandable microcapsules to a temperature equal to or higher than (i.e., not lower than) the foaming start temperature of the thermally expandable microcapsules.

The thermally expandable microcapsules are not particularly limited in type, and publicly-known thermally expandable microcapsules may be used. For example, the thermally expandable microcapsules may each be configured such that hydrocarbon is encapsulated within a shell made of a resin. Examples of such thermally expandable microcapsules include Matsumoto Microsphere (registered trademark) manufactured by Matsumoto Yushi-Seiyaku Co., Ltd., such as F and FN series (unexpanded types) and F-E, F-DE, and MFL series (pre-expanded types).

The second bubbles are the bubbles formed in the foamed wall part 12 other than the first bubbles. The second bubbles may be, for example, bubbles formed by foaming caused by a chemical foaming agent. The chemical foaming agent is a chemical substance which is in a solid form (e.g., powder) at room temperature and which, when heated to a temperature equal to or higher than (i.e., not lower than) a foaming start temperature, generates a gas (e.g., nitrogen gas or carbon dioxide gas) to cause the material to foam. The second bubbles can be formed, for example, during the production process of the weather strip 10 by adding a chemical foaming agent to the foamed wall part 12 and heating it to a temperature equal to or higher than the foaming start temperature of the chemical foaming agent.

The chemical foaming agent is not particularly limited in type, and a publicly-known chemical foaming agent may be used. Examples of the chemical foaming agent include azodicarbonamide (ADCA), 4,4′-oxybis(benzenesulfonyl hydrazide) (OBSH), and N,N′-dinitropentamethylenetetramine (DPT).

It should be noted that the second bubbles are not limited to bubbles derived from a chemical foaming agent and may be any bubbles other than the first bubbles. In other words, the second bubbles may also include bubbles derived from sources other than thermally expandable microcapsules and a chemical foaming agent.

A first bubble and a second bubble are distinguishable from each other on the basis of whether or not a shell material of the expanded thermally expandable microcapsules is present in at least part of an inner wall surrounding the bubble in the foamed wall part 12. The shell material of the thermally expandable microcapsules is, for example, a thermoplastic polymer material, and examples of the thermoplastic polymer material include an acrylic-based resin and a vinylidene chloride-based resin.

Since the first bubbles are configured that the voids created by foaming are encapsulated within the capsules of the thermally expandable microcapsules, each first bubble is less likely to be connected with another first bubble or a second bubble to form a single bubble. As such, by containing the first bubbles, the foamed wall part 12 is able to have a high number density of bubbles. Note here that “a high number density of bubbles” refers to a condition where the number of bubbles per unit area in a given cross section of the foamed wall part 12 is large.

As the number density of bubbles formed in the foamed wall part 12 increases, it is possible to achieve a greater reduction in water absorption rate of the foamed wall part 12 while reducing the specific gravity of the foamed wall part 12 by increasing the total volume of voids formed in the foamed wall part 12. In a case where the number density of bubbles is high, the size of each bubble becomes relatively smaller. This reduces the overall amount of water infiltrating the foamed wall part 12 when water penetrates into a single bubble. Thus, it is possible to maintain the water absorption rate of the foamed wall part 12 at a low level.

In contrast, in a case where the number density of bubbles is low, the volume of each individual bubble increases as the specific gravity decreases. This is because, in order to reduce the specific gravity of the foamed wall part 12, it is necessary to increase the total volume of voids within the foamed wall part 12. Consequently, the lower the number density of bubbles, the greater the amount of water infiltration into the foamed wall part 12 when water penetrates a single bubble, and the higher the water absorption rate of the foamed wall part 12. In a case where the foamed wall part 12 has formed therein not less than 200 bubbles per mm², it is possible to also decrease the water absorption rate of the foamed wall part 12 while reducing the specific gravity of the foamed wall part 12.

Further, in a case where the number density of bubbles formed in the foamed wall part 12 is high, the area ratio and the density of the portions occupied by materials such as rubber (i.e., the non-void portions) in a given cross section of the foamed wall part 12 can also be increased. This enables an improvement in bonding strength in bonding of given cross sections of the foamed wall part 12 to each other, in cases such as bonding end surfaces of the weather strip 10 to each other. This is due to an increase in area of the portions that come into contact with each other and be bonded to each other on the bonding surfaces. In a case where the number of bubbles formed in the foamed wall part 12 is not less than 200/mm², a good bonding strength between given cross sections of the foamed wall part 12 is achieved.

It is known that the surface roughness of a foamed material increases as the size of bubbles is increased. By increasing the number density of bubbles formed in the foamed wall part 12, it is possible to reduce the size of each bubble and to thereby reduce the surface roughness of the foamed wall part 12. In a case where the number of bubbles formed in the foamed wall part 12 is not less than 200/mm², the surface of the foamed wall part 12 can be made smooth, so that the appearance and feel of the weather strip 10 are improved.

Further, by increasing the number density of bubbles formed in the foamed wall part 12, it is possible to reduce the formation of creases on the foamed wall part 12. This is because the material, such as rubber, is densely formed within the foamed wall part 12, so that a restoring elastic force with which the creased surface of the foamed wall part 12 returns to an original state is more easily reinforced by a dense three-dimensional structure formed inside the foamed wall part 12.

The thickness T of the foamed wall part 12 is not less than 1.0 mm and not more than 2.0 mm, and may also be not less than 1.0 mm and not more than 1.5 mm, not less than 1.1 mm and not more than 1.5 mm, or not less than 1.2 mm and not more than 1.4 mm. The thickness T of the hollow sealing part 11 and the foamed wall part 12 refers to the thickness of a wall of the hollow sealing part 11 which wall forms the hollow space 13, and corresponds to the length of a portion indicated as thickness T in FIG. 2.

The specific gravity of the foamed wall part 12 is not more than 0.45, and more preferably not more than 0.40. The smaller the specific gravity of the foamed wall part 12, the more lightweight the weather strip 10 can be made. It is more preferable that the overall specific gravity of the weather strip 10 be not more than 0.45. The lower limit value of the specific gravity of the foamed wall part 12 is not particularly limited, but may be not less than 0.10 from the viewpoint of maintaining the sealing performance of the foamed wall part 12. In the present specification, the term “low specific gravity” refers to a small value of specific gravity that is not more than 0.45.

The specific gravity of the foamed wall part 12 can be measured by a method in conformity with JIS K 6268:1998, using a sample obtained by separating the foamed wall part 12 from the weather strip 10, for example, by cutting the foamed wall part 12 out. Specifically, the weight (g) of the sample in air is measured. Next, the weight (g) of the sample when immersed in water is measured. The specific gravity is determined using the following Equation (1).

$$Specific gravity = Weight in air / Weight when immersed in water \qquad ( 1 )$$

It is preferable that the foamed wall part 12 have a water absorption rate of not more than 5.0%. The water absorption rate of the foamed wall part 12 is more preferably not more than 4.5%, and even more preferably not more than 4.0%. The lower the water absorption rate of the foamed wall part 12, the more preferable. The water absorption rate of the foamed wall part 12 may even be 0%. In the present specification, the term “low water absorption rate” refers to a small value of water absorption rate that is not more than 5.0%.

The water absorption rate of the foamed wall part 12 can be measured by the following method: The weight of a sample obtained by separating the foamed wall part 12 from the weather strip 10, for example, by cutting the foamed wall part 12 out, is measured. The sample is immersed in distilled water at 23° C. such that an upper end of the sample is approximately 50 mm below the water surface. The water is then depressurized to 17 kPa and left for 3 minutes. Subsequently, the pressure is returned to normal pressure, and the sample is left in that state for another 3 minutes. Then, the sample is taken out of the water, water droplets on the surface of the sample are wiped off, and the weight of the sample is measured within 30 minutes. The water absorption rate is determined using Equation (2) below, where W0 is the weight (g) of the sample before the test, and W1 is the weight (g) of the sample after the test.

$$Water absorption rate ( \% ) = ( W 1 - W 0 ) / W 0 \times 100 \qquad ( 2 )$$

In the foamed wall part 12 having the thickness T as described above, it has conventionally been difficult to also reduce the water absorption rate while reducing the specific gravity through foaming. The inventors of the present invention have found that, by employing a configuration in which the number of bubbles formed in the foamed wall part 12 is not less than 200/mm² and some of the bubbles are derived from thermally expandable microcapsules, it is possible to attain a low water absorption rate (e.g., not more than 5.0%) while achieving a specific gravity of not more than 0.45.

According to such a configuration, it is possible to provide a hollow sealing part 11 (foamed wall part 12) that has both a reduced wall thickness and a low specific gravity while maintaining a low water absorption rate. As a result, the weather strip 10 can be made lightweight and requires a smaller amount of material in production of the weather strip 10. Such effects can contribute, for example, to achieving Goal 12 “Ensure sustainable consumption and production patterns” of the Sustainable Development Goals (SDGs) advocated by the United Nations.

### Method for Producing Weather Strip 10

The weather strip 10 can be produced by a conventionally known method. For example, the weather strip 10 may be manufactured by extrusion molding, by die molding, or by a combination of these methods.

In molding of the weather strip 10, thermally expandable microcapsules and a chemical foaming agent are added to the material from which the foamed wall part 12 is to be made. Heating the foamed wall part 12 in this state causes the thermally expandable microcapsules to expand and the chemical foaming agent to generate foam. As a result, the first bubbles and the second bubbles are formed. It is preferable that the heating of the foamed wall part 12 also serve as the heating for molding the weather strip 10.

Note that, in an aspect, the foamed wall part 12 may contain thermally expandable microcapsules while not containing a chemical foaming agent. In other words, the foamed wall part 12 may not contain the second bubbles. Even in such an aspect, it is possible to achieve both a low specific gravity and a low water absorption rate in the foamed wall part 12. However, from the perspective of achieving both a lower specific gravity (higher foaming) in the foamed wall part 12 and lower production costs, the foamed wall part 12 is preferably configured to contain both thermally expandable microcapsules and a chemical foaming agent, as this configuration allows for easier increase in the foaming volume.

Aspects of the present invention can also be expressed as follows:

A weather strip in accordance with Aspect 1 of the present invention is a weather strip to be attached to an automobile, the weather strip including a hollow sealing part having a hollow space formed therein, wherein the hollow sealing part includes a foamed wall part that is at least part of a wall forming the hollow space, and the foamed wall part (i) has bubbles formed therein, the number of the bubbles being not less than 200/mm² in a given cross section, at least some of the bubbles each being derived from a thermally expandable microcapsule, (ii) has a specific gravity of not more than 0.45, and (iii) has a thickness of not less than 1.0 mm and not more than 2.0 mm.

A weather strip in accordance with Aspect 2 of the present invention may be configured such that, in Aspect 1, the foamed wall part has a water absorption rate of not more than 5.0%.

### Supplementary Note

The present invention is not limited to the embodiments, but can be altered by a skilled person in the art within the scope of the claims. The present invention also encompasses, in its technical scope, any embodiment derived by combining technical means disclosed in differing embodiments.

### EXAMPLES

The following will describe an Example of the present invention.

With respect to each of the weather strips of Example 1 of the present invention and Comparative Examples 1 to 3, an image of a foamed wall part in a cross section taken along the line II-II indicated in FIG. 1 (a cross section as shown in FIG. 2) was captured with use of a digital microscope. The number of bubbles per mm² in the captured image was counted by visual observation. Further, the water absorption rate of the foamed wall part of each of the weather strips of Example 1 and Comparative Example 1 was measured in accordance with the method described in “Description of Embodiments”.

Each weather strip was manufactured using EPDM as a material forming the weather strip. The weather strip of Example 1 was produced by adding thermally expandable microcapsules (Matsumoto Microsphere, manufactured by Matsumoto Yushi-Seiyaku Co., Ltd.) and chemical foaming agents OBSH and ADCA to the foamed wall part as bubble-forming agents. The weather strip of Comparative Example 1 was produced by adding only the chemical foaming agents OBSH and ADCA to the foamed wall part as bubble-forming agents. The weather strip of Comparative Example 2 was a commercially available product. Although the detailed production conditions of the weather strip of Comparative Example 2 are unknown, the weather strip of Comparative Example 2 does not contain bubbles derived from thermally expandable microcapsules. The weather strip of Comparative Example 3 was manufactured by adding only the chemical foaming agents OBSH and ADCA to the foamed wall part as bubble-forming agents.

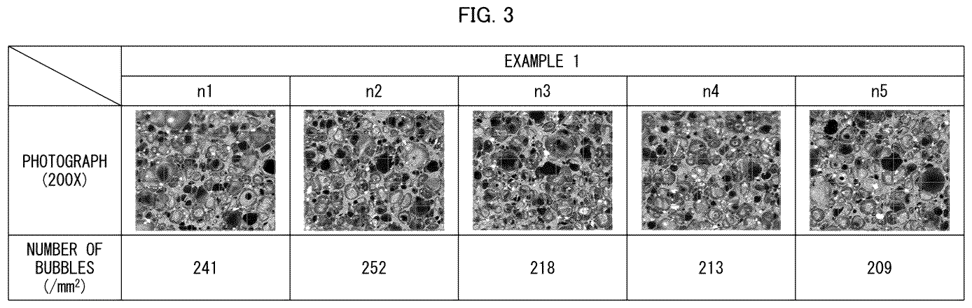

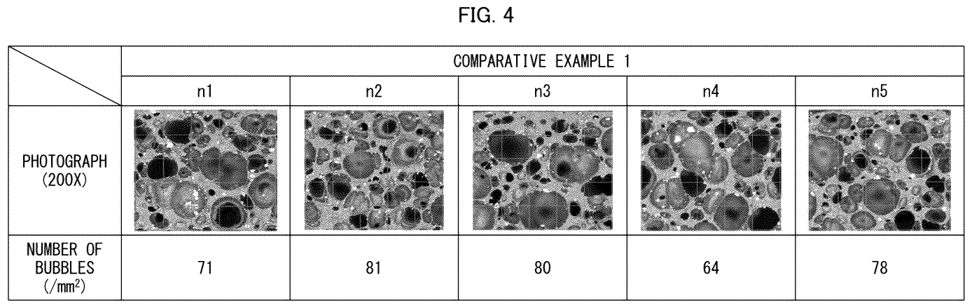

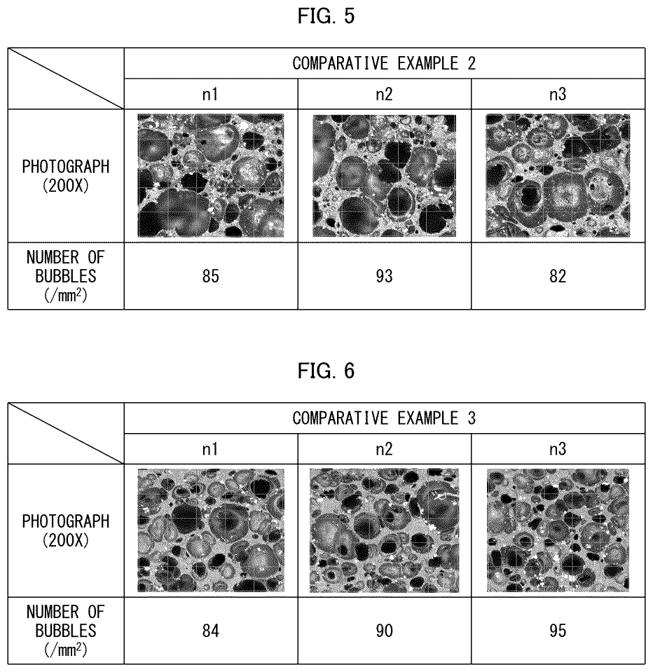

FIGS. 3 to 6 are diagrams for the respective weather strips in accordance with Example 1 and Comparative Examples 1 to 3, each of the diagrams showing cross-sectional photographs of the foamed wall part of the weather strip and the number of bubbles in the foamed wall part. For each of Example 1 and Comparative Example 1, the number of bubbles was counted at five locations within a captured image. For each of Comparative Examples 2 and 3, the number of bubbles was counted at three locations within a captured image.

As shown in FIGS. 3 to 6, the foamed wall part of the weather strip of Example 1 had not less than 200 bubbles per mm² formed at all of the locations in the cross section, whereas the foamed wall parts of the weather strips of Comparative Examples 1 to 3 each had not more than 100 bubbles per mm² formed at all of the locations in the cross-section.

Further, the foamed wall part of the weather strip of Example 1 had a water absorption rate of 0.8%, whereas the foamed wall part of the weather strip of Comparative Example 1 had a water absorption rate of 2.0%.

From the above results, it was demonstrated that the foamed wall part of the weather strip of Example 1 achieves a good water absorption rate due to having not less than 200 bubbles per mm², at least some of which are derived from thermally expandable microcapsules.

### REFERENCE SIGNS LIST

1: Automobile
2: Door
3: Flange
4: Door-side seal
10: Weather strip
11: Hollow sealing part
12: Foamed wall part
13: Hollow space
14: Base part
15: Lip

1. A weather strip to be attached to an automobile, the weather strip comprising a hollow sealing part having a hollow space formed therein, wherein
the hollow sealing part includes a foamed wall part that is at least part of a wall forming the hollow space, and
the foamed wall part
has bubbles formed therein, the number of the bubbles being not less than 200/mm² in a given cross section, at least some of the bubbles each being derived from a thermally expandable microcapsule,
has a thickness of not less than 1.0 mm and not more than 2.0 mm, and
has a specific gravity of not more than 0.45.

2. The weather strip as set forth in claim 1, wherein the foamed wall part has a water absorption rate of not more than 5.0%.
